(19) United States
(12) Patent Application Publication
(10) Pub. No.: US 2014/0046717 A1
(43) Pub. Date: Feb. 13, 2014

(54) ORGANIZATION SYSTEM AND METHOD FOR CALENDAR APPLICATIONS

(71) Applicant: TOP SCHOLAR TECHNOLOGY, LLC, Ann Arbor, MI (US)

(72) Inventors: Cheng Yuan, Lansing, MI (US); Mark Christopher Roszell, Ann Arbor, MI (US)

(73) Assignee: TOP SCHOLAR TECHNOLOGY, LLC, Ann Arbor, MI (US)

(21) Appl. No.: 13/961,543

(22) Filed: Aug. 7, 2013

Related U.S. Application Data
(60) Provisional application No. 61/680,924, filed on Aug. 8, 2012.

(51) Int. Cl. G06Q 10/10; G06Q 50/20

(52) U.S. Cl. CPC G06Q 10/1097; G06Q 50/20
USPC 705/7.21

(57) ABSTRACT

A system for parsing data from a document and populating an electronic calendar, the system including a converting tool adapted to convert a document into a plain text format having plain text data. A parser is provided that is operable to process the plain text data, identify at least a target date and task, and convert the target date and task into an electronic calendar format file adapted to cooperate with an electronic calendar and place the target date and the task into the calendar.

### CROSS-REFERENCE TO RELATED APPLICATIONS

This application claims priority benefit to provisional patent application number 61/680,924 filed Aug. 8, 2012, the subject matter of which is incorporated by reference in its entirety.

### BACKGROUND

The present disclosure relates to systems and methods of obtaining and parsing data from a document and converting that data into a useable format to provide information to populate an electronic calendar, particularly the data is received and imported into an electronic computer-based calendar.

### DESCRIPTION OF THE RELATED ART

Electronic calendars are well known and popular. Such calendars are accessible electronically through a personal computer or portable device such as a phone or tablet. These calendars can be hosted locally or accessed remotely through a web-application. The calendars can further be hosted through a cloud. Electronic calendars are especially valuable for business environments to provide convenient schedule and task management. Typical calendar systems allow for meetings to be scheduled through email and the like providing efficient methods of populating important events and such into a personal calendar. These calendars can be shared as well and viewable by others to check availability for future dates.

Typically, events are populated into a calendar manually or through electronic files operable to be imported into the calendar. Such files include “i-Calendar” or “.ics” files. The term “.ics” is an extension format commonly used in the art. The term “i-Calendar” is synonymous with “iCalendar”. The i-Calendar file is a computer file format which allows internet users to send meeting requests and tasks to other internet users, via email, or sharing files with an extension of .ics. Recipients of the iCalendar data file (with supporting software, such as an email client or calendar application) can respond to the sender easily or counter propose another meeting date/time. iCalendar is used and supported by a large number of calendar software products in the industry. iCalendar is designed to be independent of the transport protocol.

Manually inputting important dates into a calendar can be tedious and time consuming. For example, the time it takes a college student to populate his or her electronic calendar with due dates for assignments and test dates may be several hours to incorporate a full time schedule. Moreover, manually inputting the data into the calendar leaves significant room for user error causing risk of missing important dates. No convenient system currently exists to solve this long felt need to provide convenient and automatic calendar populating given a schedule or document, whether physically scanned or provided electronically.

### SUMMARY

The present disclosure relates to a system for parsing data from a document and populating an electronic calendar, the system includes (a) a converting tool adapted to convert a document into a plain text format having plain text data; and (b) a parser the parser operable to process the plain text data, identify at least a target date and task, and convert the target date and task into an electronic calendar format file adapted to cooperate with an electronic calendar and place the target date and the task into the calendar. In an example, the parser and converting tool can be hosted on a computing device. In a further example, the parser and converting tool are hosted on a remote server accessed through a web-based application remotely by a user. The electronic calendar can be hosted on a local or remote server and viewable from a computing device. The computing device typically includes a display. Example computing devices include but are not limited to a personal computer, laptop, smart phone, tablet or the like. The document can be selected from the group consisting of a physical copy, an electric copy, or a combination thereof.

The parser can be adapted to identify content associated with the document, search for purchasing options through the internet and provide the purchasing options associated with the content to a user. In an example, the document is a course syllabus for a course having a plurality of target dates associated with tasks selected from the group consisting of homework, quizzes, tests, class meetings, and combinations thereof. The syllabus can optionally provide course reading material that may be purchased, such as books or the like, and the parser further allows for identifying these materials to be searched on the internet and providing a user with purchasing options for the identified material. The target date can further include detailed target times associated with the time of day for the task, such as for attending class or other appropriate meeting. In a further example, the parser performs tasks as outlined in FIG. 2.

The present disclosure further provides for a method of populating a calendar comprising the steps of: (a) converting a document, scanned, downloaded, and/or uploaded, into plain text format data; (b) electronically processing the text data through a parser to identify target data such as due dates and tasks; (c) converting the target data into an electronic calendar format file adapted to cooperate with the electronic calendar hosted on a local or remote server and viewable from a computing device having a display such as a personal computer, laptop, smart phone, tablet or the like; and (d) populating the electronic calendar with the target data.

Other features and advantages of the present disclosure will be readily appreciated, as the same becomes better understood after reading the subsequent description taken in conjunction with the accompanying drawings.

### BRIEF DESCRIPTION OF THE DRAWINGS

The features and advantages of the present invention will become more readily apparent when taken in conjunction with the following figures and illustrations.

FIG. 1 illustrates a schematic diagram according to the present disclosure of an example process of populating a calendar with relevant due dates from a calendar.

FIG. 2 illustrates a schematic diagram according to the present disclosure of an example process of parsing data from a given document.

### DESCRIPTION

The present disclosure provides for a system and method of populating an electronic calendar with target dates and times obtained from a document. The document can be a hard copy or physical document and then scanned electronically or obtained electronically. In an example, a document can be transmitted electronically through email or obtained electronically by downloading or uploading from a particular web location. The document can also be saved to a portable storage device such as a flash drive and accessed when plugged into a computing device.

A computing device can be any typical device that hosts computer programs and allows visual display of the content associated with those programs. A personal computer, laptop, smartphone, tablet and others are within the scope of a computing device.

Electronic calendars can be accessed and viewable from a computing device. A calendar program or application can be hosted locally on the device or remotely on a server or through a cloud format. A user of an electronic calendar may be able to access his or her personal calendar via any computing device through a web-based application using the internet. For example, if user may have a private user account set up through GOOGLE which includes a GOOGLE CALENDAR account. The user can access his calendar by logging into his account from any remote location with internet access. His calendar can include scheduled items including user specified and populated target dates such as birthdays and anniversaries or due dates for certain projects, academic assignments, or professional tasks. A specific time window can also be included and displayed on the calendar item.

The present disclosure provides for obtaining a document having at least one target due date and converting that document into a calendar based data file to be uploaded into a user specific electronic calendar. In an example, a user can be a university or college student who is taking a particular class or course of study. The user may be given a course syllabus that includes several key target dates associated with the course. In this example the course may last fifteen weeks ending with a final exam. The syllabus may have a grade distribution based on a combination of homework grades, quiz grades, test grades, and a final exam score. During the course, three major exams will be taken by the students on specified dates, times and locations. The dates, times, and locations of quizzes can also be provided as well as class schedule and due dates for homework. Other related information can be provided as well including any out of class activities, field trips, and/or course materials which should be purchased and used for studying and homework. For example, the syllabus may list one or more textbooks, novels, or works of nonfiction that serve as a basis for the class.

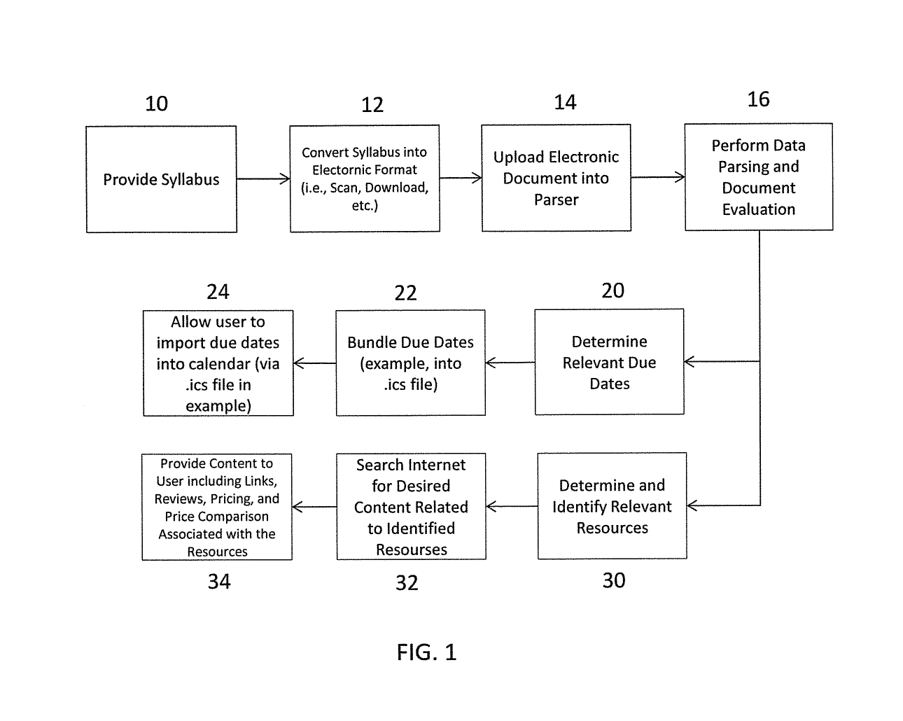

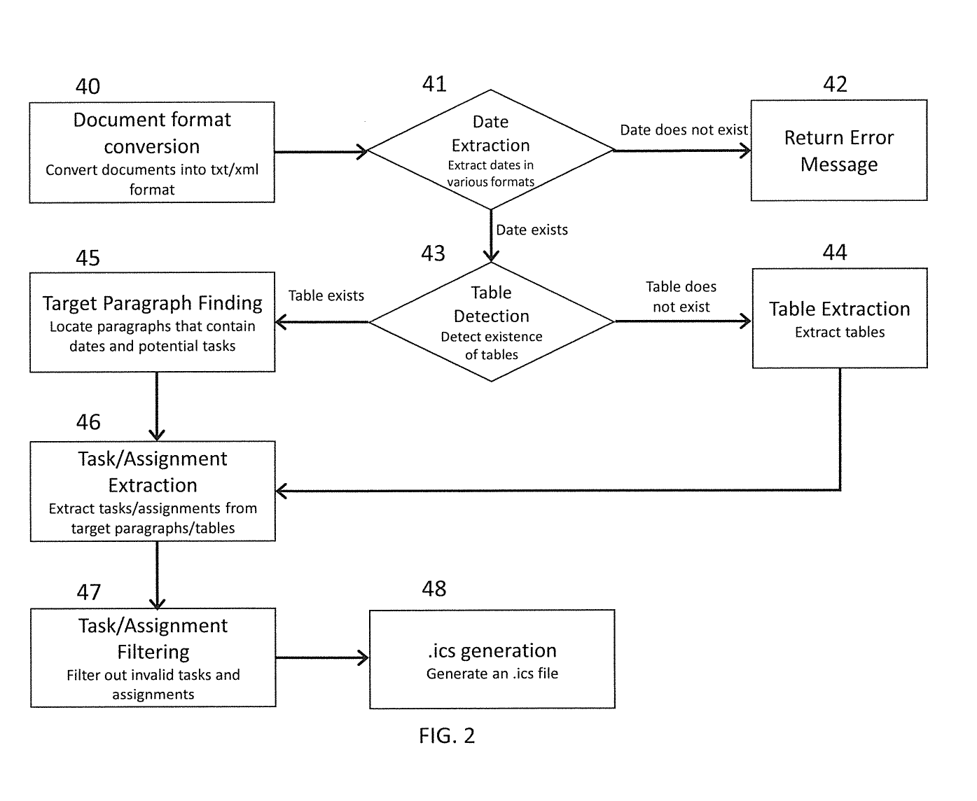

The present disclosure provides for a system and method of processing the information provided in the syllabus and populating a calendar application based on identified target due dates and task information associated with the target dates such as times and location and assignments. Referring to FIGS. 1 and 2, an example flow diagram is schematically illustrated further building on the university example discussed hereinabove. In box 10, the system begins by providing a syllabus for a particular class.

The syllabus can be handed-out in class, possibly by the instructor or teaching assistant, sent to each student via email, or accessed from a dedicated course website. The syllabus is converted to or provided in an electronic format as the system and methodology progresses to box 12. If it is scanned into a computer using a standard scanner for example, it can be captured in a .pdf or other image format. The syllabus can be downloaded such that it exists to the user as an electronic document in a variety of formats.

The system and methodology then progresses to box 14 where the document is uploaded into a parsing tool. The parsing tool is interchangeably referred to as a parser. The parser then performs a data parsing step at box 16 where the document is evaluated for desired content. The system and methodology then advances to either or both of box 20 and 30. Following from box 20, the parser identifies desired information from the document such as relevant due dates along with tasks and information associated with those tasks. Additional information associated with a task can include homework assignments, due dates, class times, out-of-class lecture series, test dates, and the like. The information identified in the parsing step is then bundled and converted into an electronic calendar readable format in box 22, for example, an “.ics” file extension. Moving to box 24, the bundled calendar readable file can then be uploaded by the user into a user specific electronic calendar application to populate their calendar with the information, data, and due dates identified by the parser.

The data obtained through parsing step 16 can further continue through the system and methodology at box 30 where relevant resources associated with the course and provided on the syllabus are determined and identified. The syllabus, for example, may list one or more textbooks, works of literature, or course packets to be studied during the class. These materials can, and often do, serve as the basis for the class. The subject matter of these resources is typically that which is tested during the semester through tests, essays, quizzes, and a final exam. Once the relevant resources are identified, the system progresses to box 32 where desired content is found using web-based searching that relates to such resources. The content is then provided to the user through the computing device display at box 34. The content can include reviews of the material, pricing, links to purchase such resources, comparable prices among different vendors for the resources, and other information within the scope of this disclosure.

FIG. 2 illustrates an example flow diagram of the specific system and process of the parsing step. The document is first converted in box 40 into a text readable format such as “.txt” or “.xml” format. The system and methodology then advances to box 41 where date determination is performed and referred to as date extraction. If no date exists, then an error message is generated at box 42. If at least one date exists, then the system advances to box 43. Box 43 serves as table detection to determine if any tables exist in the document. The tables may include valuable information for the parser to identify and bundle in a meaningful way later. Often syllabi list dates, assignments, and other information in tables. If a table exists then the system and methodology advances to box 44 for table extraction followed by task and assignment extraction at box 46. If no table exists but the date exists, then the system proceeds to box 45 to identify target paragraphs. The target paragraph step locates and identifies paragraphs that contain dates and potential tasks. The system continues to box 46 for task and assignment extraction where any tasks and assignments or other information is extracted from either the identified target paragraphs (box 45) or the extracted tables (box 44). The task and assignment extraction is followed by a filtering step at box 47 which filters out any invalid tasks or assignments. This can be preset to determine conditions which constitute an invalid task or assignment based on predefined criteria. Following the filtering step 47 is generation of the electronic calendar readable file at box 48.

The parser is operable in taking an example .doc or .pdf course syllabus document and converts it into a plain text (.txt) file. Using regular expressions, the parser looks for date patterns, for example, April 15, 20xx, 4/15, Apr. 15, and the like, that appear. These dates may correspond to assignment dates or other relative information. The parser can then use a variety of different pattern recognition algorithms to pull assignment text strings out of the syllabus document. These assignment strings of text are then bundled together into an .ics file, which is importable into a diverse group of calendar applications.

Many modifications and variations of the present disclosure are possible in light of the above teachings. Therefore, within the scope of the appended claim, the present disclosure may be practiced other than as specifically described.

What is claimed is:

1. A system populating an electronic calendar, the system comprising:
(a) an electronic computer conversion tool provided on a computing device having a processor, the conversion tool adapted to convert a document into a plain text format having plain text data; and
(b) a parser for parsing data from a document, the parser hosted on the computing device and operable to process the plain text data, identify target dates and tasks, and convert the target dates and tasks into an electronic calendar format file adapted to cooperate with an electronic calendar and place the target dates and the tasks into the calendar.

2. The system of claim 1 wherein the parser and converting tool are hosted on a computing device.

3. The system of claim 1 wherein the parser and converting tool are hosted on a remote server accessed through a web-based application remotely by a user.

4. The system of claim 1 wherein the document is selected from the group consisting of a physical copy, an electric copy, or a combination thereof.

5. The system of claim 1 wherein the parser is programmed to identify content provided in the document and search for purchasing options through the internet and provide the purchasing options and information associated with the content to a user.

6. The system of claim 1 wherein the document is a course syllabus for an educational course having a plurality of target dates associated with tasks selected from the group consisting of homework, quizzes, tests, class meetings, and combinations thereof.

7. The system of claim 6 wherein the syllabus optionally provides course reading material that may be purchased and the parser further allows for identifying these materials to be searched on the internet and providing a user with purchasing options and other information for the identified material.

8. The system of claim 1 wherein the target date further comprises detailed target times associated with the time of day for the task.

9. The system of claim 1 wherein the parser is operable to detect and extract from the document data associated with dates, tables, paragraphs, assignments and tasks, and filter invalid tasks and assignments.

10. A method of populating an electronic calendar comprising the steps of:
(a) converting a document into plain text format data through a computer device having a processor and a display;
(b) electronically processing the text data through a parser provided on the computer;
(c) identifying target data with the parser and collecting the target data separate from other data identified in the plain text format data;
(d) converting the target data into an electronic calendar format file adapted to cooperate with the electronic calendar hosted on a local or remote server and viewable from a computing device having a display; and
(e) populating the electronic calendar with the target data.

11. The method of claim 10 wherein the document conversion is achieved through any of scanning, downloading, and uploading the document using a computer.

12. The method of claim 10 wherein the target data includes due dates and tasks associated with the document.

13. The method of claim 10 wherein the computer device is selected from the group consisting of a personal computer, a laptop, a smart phone, and a tablet.

14. The method of claim 10 wherein the document is associated with a particular educational course having a plurality of due dates and tasks associated with calendar dates.

15. The method of claim 14 wherein the educational course provided by a post-secondary educational institution.

16. The method of claim 15 further comprising the steps of identifying resources available through online venders to purchase associated with the particular educational course.

17. A method of populating an electronic calendar using a parser provided on a computing device comprising the steps of:
(a) converting a document into plain text format data through a computer device having a processor and a display;
(b) electronically processing the text data through a parser provided on the computer;
(c) detecting and extracting dates provided on the document;
(d) detecting and extracting tables provided on the document;
(e) detecting and extracting target paragraphs containing dates and tasks provided on the document;
(f) detecting and extracting tasks and assignments provided on the document;
(g) filtering invalid tasks and assignments;
(h) generating an electronic calendar format file adapted to cooperate with the electronic calendar hosted on a local or remote server and viewable from a computing device having a display.
